(19) United States
(12) Patent Application Publication
(10) Pub. No.: US 2026/0134690 A1
(43) Pub. Date: May 14, 2026

(54) Open Architecture for Recognizing Objects of Interest

(71) Applicant: The Government of the United States of America, as represented by the Secretary of Homeland Security, Washington, DC (US)

(72) Inventors: Justin Keear, Alexandria, VA (US); Erick Rekstad, Annandale, VA (US); Edwin Martinez, Fort Washington, MD (US)

(73) Assignee: The Government of the United States of America, as represented by the Secretary of Homeland Security, Washington, DC (US)

(21) Appl. No.: 19/058,826

(22) Filed: Feb. 20, 2025

Related U.S. Application Data
(60) Provisional application No. 63/557,107, filed on Feb. 23, 2024.

(51) Int. Cl. G06V 20/52; G01V 5/20; G01V 5/22; G06V 10/764; G06V 10/778; G06V 40/10; G07C 9/10; G08B 21/02

(52) U.S. Cl. CPC G06V 20/52; G01V 5/22; G01V 5/271; G06V 10/764; G06V 10/7788; G06V 40/10; G07C 9/10; G06V 2201/05; G08B 21/02

(57) ABSTRACT

An anomaly and object recognition system configured to scale connected transportation security equipment in order to support different screening needs at ports of entry and provide a robust failsafe approach. The system may be configured to determine anomalies while maintaining privacy of passengers and their baggage. The system may leverage a suite of algorithms to analyze the subset of data identified by the anomaly detection algorithm. The system may adhere to various cybersecurity standards in part by limiting data shared with remote screening terminals.

### CROSS-REFERENCES

This application is a nonprovisional application that claims the benefit of priority U.S. Provisional Application No. 63/557,107 entitled “Open Architecture for Recognizing Objects of Interest,” filed Feb. 23, 2024, the content of which is incorporated by reference in its entirety.

### STATEMENT OF GOVERNMENT INTEREST

The present invention was made by employees of the United States Department of Homeland Security in the performance of their official duties.

### FIELD

The field of invention generally relates to systems and methods for screening persons and objects for anomalies and objects of interest.

### BACKGROUND

The Transportation Security Administration (TSA) serves a vital role in detecting objects of interest on persons and within objects (e.g., containers, accessible property, checked baggage, etc.) attempting to gain access to a port of entry. Current techniques for screening persons and objects provide a closed-architecture model frequently employing proprietary software design that cannot easily be updated or improved.

### SUMMARY

Disclosed are systems and methods to conduct the screening for objects of interest. Systems and methods involved in screening may include logic to enhance the customer experience. The screening systems may be designed to improve agility and flexibility of screening and security protocols. Certain configurations of the present invention may be designed such that the improvements and innovations in security and screening technology may be rapidly incorporated into said configurations. Some configurations of the invention may be designed so that the configurations incorporate interconnected and interoperable technologies. Some configurations may also employ advanced cybersecurity capabilities to ensure cyber resilience.

Some configurations of the invention may involve designing the systems and methods to utilize computing and hardware standards. In certain configurations, various components may be interoperable such as software and hardware. Industry partners (e.g., designing hardware and software for embodiments of the present invention) may create subcomponents featuring improvements such as new detection algorithms, user interfaces, reporting systems, etc.

Some configurations of the present invention may provide multiple implementations and scaling of connected transportation security equipment to support the different screening needs at airports and provide a robust failsafe approach. Some systems and methods may be configured to support a managed model architecture to determine anomalies while maintaining privacy of persons. The system may be configured to meet cybersecurity standards.

### BRIEF DESCRIPTION OF DRAWINGS

FIG. 1 illustrates a checkpoint, object recognition system, item screener, and workstation cluster.

FIG. 2 is a schematic view of the on-person screener, carry-on screener, checked item screener object recognition system and workstation cluster.

FIG. 3 illustrates a plurality of screening systems connected to a central server.

FIG. 4 illustrates an Object Recognition System (ORS) comprising an open architecture framework.

FIG. 5 illustrates another schematic view of the ORS in combination with other components.

FIG. 6 illustrates a schematic view of the ORS in combination with other components.

FIG. 7 illustrates an automated object recognition algorithm selection logic in combination with other components.

FIG. 8 illustrates an anomaly detection logic in combination with other components.

FIG. 9 illustrates a sample configuration of a TRS (Threat Recognition System), which is a specific type of an ORS. The figure also illustrates information on DICOS (Digital Imaging and Communications in Security), a standard for security screening images and related data developed through the ANSI (American National Standards Institute) accredited Standards Developing Organization NEMA (National Electrical Manufacturers Association).

FIG. 10 illustrates additional details of the TRS. The figure also illustrates information on OPSL (Open Platform Software Library), an Application Programming Interface (API) to provide a standardized interface.

### DETAILED DESCRIPTIONS OF DRAWINGS

### Persons and Operators

The invention relates generally to screening of persons and objects (e.g., containers, accessible property, checked baggage, etc.). Screening may involve a number of physical and technological techniques such as searching, imaging, recording, observing, scanning, analyzing, classifying, sniffing, filming, etc. A person is an individual that is attempting to proceed from a first position to a second position in a location. For example, a person may pass through a security checkpoint at an airport. A person may be a traveler, a passenger, or any individual attempting to gain access to a secure or semi-secure facility or location. An operator is an individual that is responsible for running one or more portions of a screening system 1.

### Screener

A screener (or screening device) may be configured to generate screening data (such as stream of commerce data). Screening data may comprise a visual media file, an image, video, metadata, context data including for example: item-image-alarm characterization, scan performance, screening performance, data on users or passengers, configuration data, and risk data).

### Visual Media File

A visual media file may be any type of file that is designed to store or display images, pictures, video, film, or visual light & sound records in a non-volatile, non-transitory form. Screening data may depict an object of interest.

### Possessions & On-person Items

A person may carry one or more objects on his or her person. A possession is any object attached, connected to, concealed, or physically controlled by the person. A possession 210A may be an on-person item 210A. An on-person screener 210 may screen for on-person items 210A. Examples of possessions include concealed guns, jewelry, a pocket knife, a piece of fruit in a pocket, medication taped to the person's leg, pins, socks, clothing, implanted materials, or any object carried by a person. A person may be screened by an “on-person” screener.

### Chattels and Carry-On Items

A chattel 220A as used herein is any physical object controlled by the person, that can be screened by the chattel screener/carry-on screener 220. Common examples of chattel include carry-on items 220A such as bags, purses, jackets, packs, stuffed animals, shoes, electronics, food, etc.

### Checked Items

An item is any physical object screened by the checked item screener 230. The checked item screener may screen checked-items 230A. A checked item is generally an object that is not accessible to a passenger during screening because the checked item is screened in an alternate location. Common examples of items include luggage, baggage, bulk goods, etc.

### Objects

An object may be a possession, a chattel, and an item. A shirt would be a possession (e.g., on-person item) if it's worn by a person passing through an on-person screener, a chattel 220A (e.g., carry-on item) if it is passes through the chattel screener (e.g., carry-on screener) 220, or an item (e.g., checked item) 230A if it passes through the item screener 230. The same shirt may be contained in a bag. A bag may also be a possession, chattel, or item.

### Object of Interest

An object of interest (or item of interest) is an object that the Object Recognition System (ORS) may be configured to detect. Examples of objects of interest may include a threat or contain context data identifying a particular object (item) as containing or likely containing a threat. Threats may include explosives, guns, knives, weapons and other prohibited items (bats, screwdrivers, etc.). Not all objects of interest are necessarily threats. An object of interest can be any object that the screening system 1 is configured to detect. An object of interest may include a region of interest. A region of interest is a particular region or area of digital representation of an object having characteristics containing or likely containing a threat item.

### Screening System

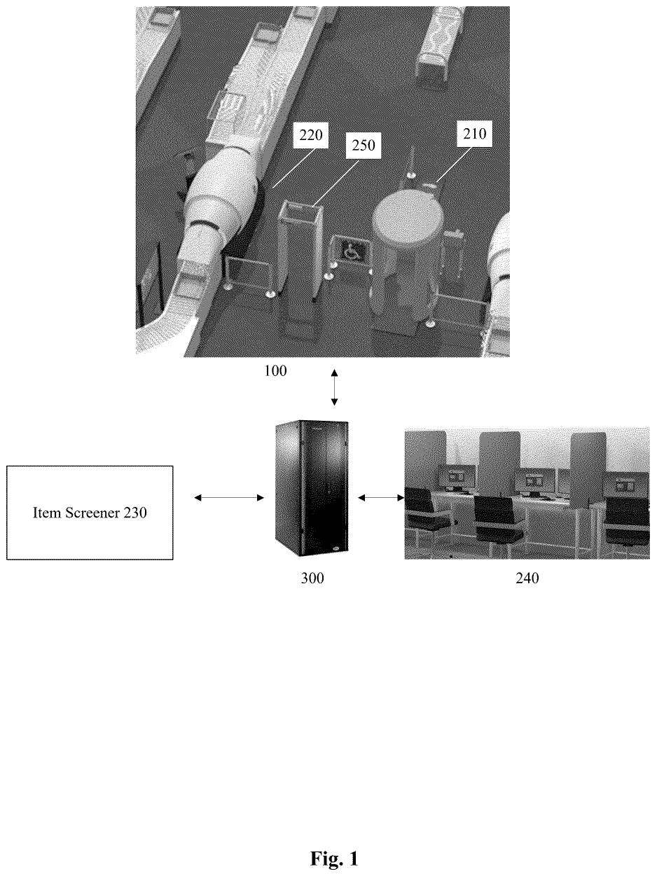

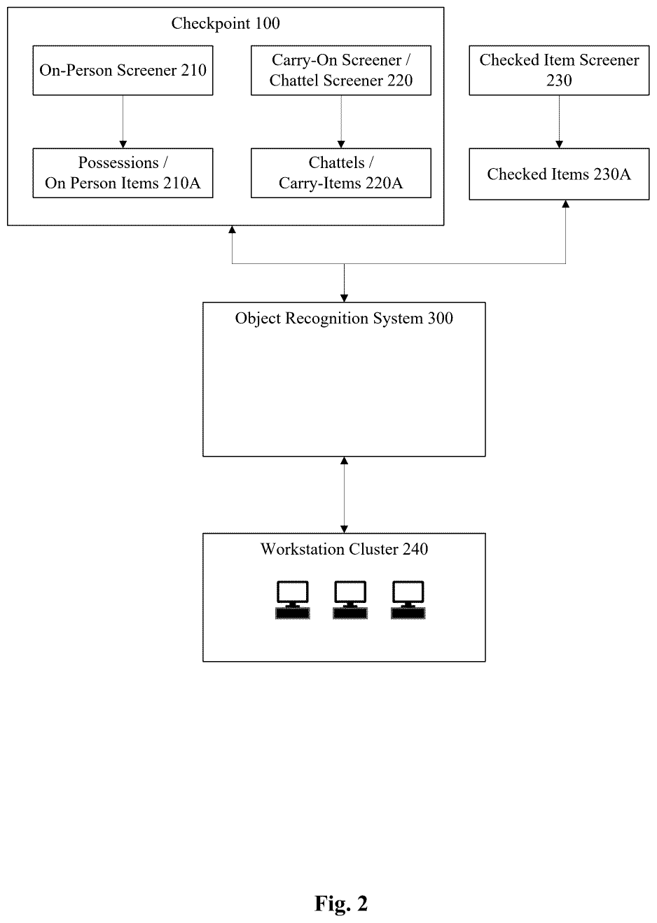

FIG. 1 and FIG. 2 depict a screening system 1 comprising components including a chattel screener 220, a checked item screener 230, on-person screener 210, a workstation cluster 240, a walk-through metal detector 250, and an Object Recognition System (ORS) 300. The chattel screener 220 may be configured to scan chattels accessible to an individual. The chattel screener 220 may be configured to generate a visual media file of a container and contents within the container. The on-person screener 210 may be configured to screen both the person and possessions of the person. The walk-through metal detector 250 is a type of on-person screener 210, but configured specifically to detect metal objects. The on-person screener 210 may be configured to generate a screening file of a person and/or possession. The on-person screener may be configured to detect any anomalies on their person and employ libraries from an API to transfer the screening file to the ORS. Examples of on-person screeners may include millimeter wave scanners, x-ray scanners, infra-red thermal conductivity scanners, etc.

FIG. 1 also depicts a security checkpoint 100 comprising a chattel screener and on-person screener. Security checkpoints may comprise an access control device for controlling a person's access between a first position and a second position.

Components in the screening system may comprise software and hardware to store screening data in a format. The format may be a common format comprising a set of standards (for example DICOS, discussed below.) Components in the screening system may comprise software, hardware and network connectivity devices to communicate with each other according to a protocol. The protocol may be a common protocol comprising set of standards (for example OPSL discussed below.) Components may have their own power supply, processor, housing, cameras, memory, storage media, etc.

The on-person scanner; chattel screener, or item screener may comprise a detector configured to detect radiation from a radiation source; a radiation source configured to irradiate radiation into a person, possession, container; item, luggage, etc. The screening system may comprise a platform comprising a loading area, a screening area for screening the container, and an exit area. The screening system may comprise a non-volatile, non-transitory, tangible storage memory configured to store an anomaly detection algorithm and an object of interest recognition algorithm. The screening system may comprise a processor configured to execute the anomaly detection algorithm and the object of interest recognition algorithm. The screening system may comprise a power supply configured to provide power to the radiation source, processor, memory, and detector; and a housing comprising the detector, radiation source, power supply, processor, memory, and screening area.

A method of using the screening system may include: detecting radiation from a radiation source with a detector; irradiate radiation into the container using a radiation source; moving the container from a loading area into a screening area, screening the container, moving the container into an exit area; storing an anomaly detection algorithm and an object of interest recognition algorithm in non-volatile, non-transitory, tangible storage memory; executing the anomaly detection algorithm and the object of interest recognition algorithm with a processor; providing electricity to the radiation source, memory, processor, and sensor using a power supply; and enclosing the detector, radiation source, power supply, processor, memory, and screening area in a housing.

A detector may include components such as a visual media collector, webcam, smartphone, point and shoot camera, satellite camera, lidar system, video camera, or other electronic device configured to capture and save light with an optic sensor. The detector may capture visual media files such as image files, pictures, graphics, optic sensor data, videos, video frames, etc.

A radiation source may be a light assembly, a laser, or other device capable of emitting a beam of photons in an area. The radiation source may comprise motors for positioning an artificial light source, an LED, a bulb, a mirror, a lens, a housing, and other optics to create and emit the radiation. The platform may be a conveyor belt, moving platform, or static platform. The platform may comprise a bin, gears, cogs, wheels, sliding surfaces, discs, walls, and top and bottom surfaces. The housing may be composed of various materials such as metal, glass, and plastics. The housing may be configured to position and protect various components of the screening system such as the radiation source, detector, and power supply. The screening system may comprise a visual media file buffer configured to store visual media files pertaining to screening objects carried by the person; the container; and contents within the container, and the like. Some screening systems may be configured not to store images of the person; objects carried by the person; the container; and contents within the container. The buffer may comprise memory or other non-volatile storage.

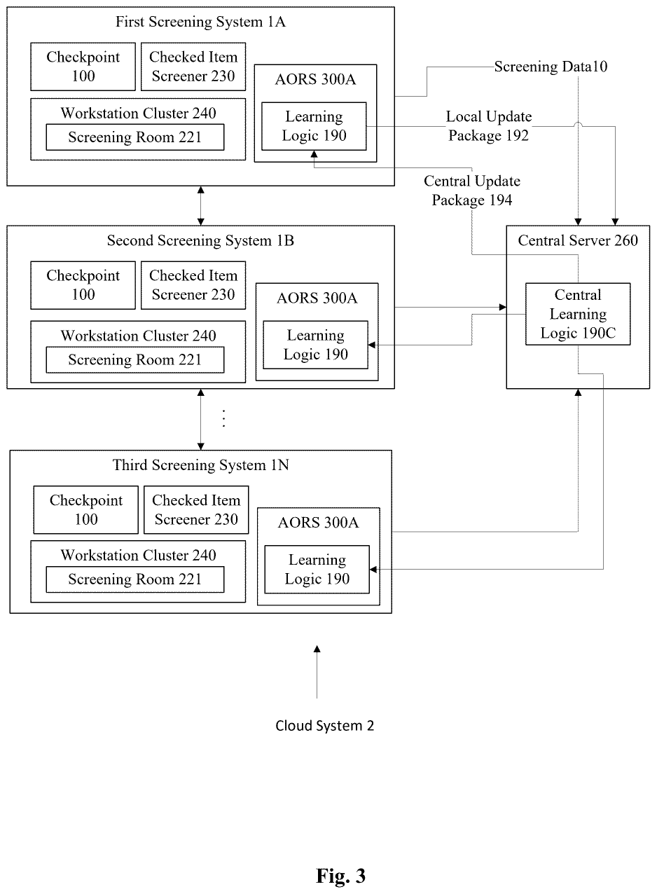

FIG. 3 illustrates that a central server 260 that may connect or be connected to N screening systems, wherein N is a natural number. Each screening system may comprise one or more checkpoints 100, checked item screeners 230, automated object recognition systems 300, and workstation clusters 240. Screening systems 1A-1N may be deployed in an airport, military base, office building, apartment building or other location. A central server 260 may comprise standard server hardware and software for managing data received from other servers. Specialized software and hardware may be installed and executed to run specific algorithms and processes on data received from the other servers. Additionally, the central server may generate specialized instructions for the other servers to execute. The central server can be a plurality of servers such as a bank of server, server farm, etc.

### Learning Logic (LL)

The screening system 1 may comprise a local learning logic (LL) 190 configured to generate local update packages 192 to improve the anomaly detection algorithm(s) (ADAs) and/or automated object of interest recognition algorithm(s) (AORAs). The local learning logic 190 may be configured to employ artificial intelligence and/or machine learning. The ORS may receive the algorithm updates 192. The ORS may install or execute the algorithm updates to improve speed, accuracy, and/or precision of the anomaly detection algorithm and/or the object recognition algorithm.

An automated object of interest recognition system (AORS) is an ORS that is configured to receive and apply automated updates to improve object of interest detection and functionality. As shown, the AORS may comprise the learning logic 190 or it may be a separate component.

The learning logic (LL) 190 may be configured to improve the object of interest detection algorithms and methodology to stay ahead of individuals that do not want these objects detected (smugglers, terrorists, etc.). For example, emerging threats may be continuously changing. One or more of the screening system(s) (1A-1N) may be configured to continuously update what it determines as “normal” screening data. Normal screening data may comprise screening data that does not contain any anomalies as detected by anomaly detection logic. A central learning logic 190C, run from the central server 260, may push update packets to the screening system(s) (1A-1N) (only systems 1A, 1B, and 1N are shown in FIG. 3). N is a natural number great than 2. Screening data that the system determines has properties outside of normal may be classified as anomalous by the anomaly detection logic (discussed below).

The learning logic (LL) may be incorporated into an individual ORS 300 or it may be installed into the central server 260. The learning logic (LL) may be configured to analyze screening data from a single screening system or a plurality of screening systems. In some examples, a central server may receive the screening data to aggregate and compile update through its central learning logic. In other examples, the learning logic of screenings systems (1A-1N) can share and aggregate data amongst themselves without utilizing a central server or central learning logic.

The learning logic or central learning logic may use artificial intelligence to incorporate improvements into its algorithm that generate the definition of “normal” screening data. The learning logic may be configured to train and update algorithms run by the ORS. The learning logic may be configured to develop a shared prediction model while keeping all the training data local, so machine learning may be performed without the need to store the data in the cloud. Under this configuration, the central learning logic may obtain screening data, improve the algorithms the ORS uses to detect anomalies and recognize objects of interest by learning from data during local screening, and then aggregate changes as a local update package 192. This local update package 192 may be transmitted through cloud sharing (and potentially encrypted) to the central server 260. The central learning logic may incorporate (average, analyze, etc.) the local update package with other local update packages (not shown for drawing clarity reason) to provide a central update package that can be distributed to one or more of the screening systems. This process may allow the central learning logic to update the learning logics (and their ORS) on a continuous basis without the need of the local learning logic to have access to all the data. Updates may be pushed into the ORS directly or through the local learning logic. Through this process the learning logic and/or central learning logic can update definitions for what “normal” screening data is. This process also protects privacy of individuals as central update packages may comprise anonymized updates that do not comprise individual characteristics about individuals or their property.

### Closed Architecture Framework (CAF)

Some prior art security screening technology solutions use a closed architecture framework. It may be more difficult for industry partners to design components for a closed architecture system (as compared to an open architecture system) because industry partners often do not have access to a specification, schematics, API, etc. to design the components. A closed architecture framework may also be vendor-specific in some cases. Specifications may be proprietary to certain manufacturers.

### Open Architecture Framework (OAF)

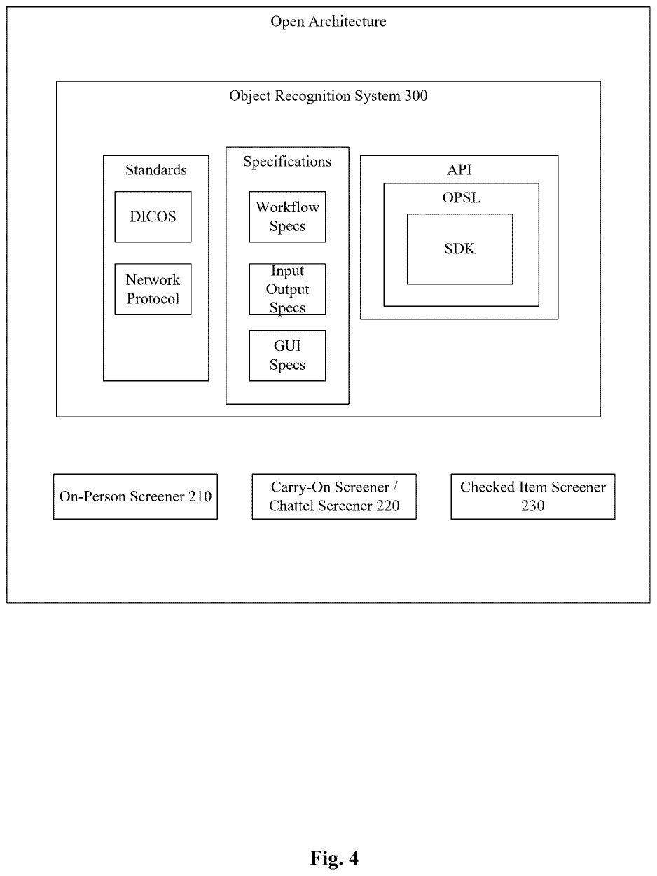

FIG. 4 shows certain elements of an open architecture framework (OAF). Configurations of the present invention that utilize an open architecture framework may provide industry partners with standards, specifications, software development kit (SDK), and an application programming interfaces (API) such as an open platform software library (OPSL) to facilitate component design and manufacture. A system may implement an OAF by comprising software and/or hardware components that conform to requirements set forth by or suggested by the OAF. One such example is a common file format for saving screening data. One example of a common format for saving screening data is DICOS and OPSL is an example of a common protocol for transferring parts of screening data.

The ORS 300, on-person screener 210, chattel screener 220, and checked item screener 230 may implement an open architecture framework.

An open architecture framework (OAF) may require components to store the screening data in a common format such as DICOS. A component may be configured to save in the common format would be open architecture compliant (OAC) at least with respect to the file format. An open architecture framework may comprise multiple requirements for compliance.

### Digital Imaging and Communications in Security (DICOS)

As set forth above, components may be configured to use the DICOS (digital imaging and communications in security) standard for security screening images and related data. The DICOS standard may provide a data exchange protocol and interoperable, extensible file format to facilitate data exchange (CT image, X-ray radiograph, trace detection signature, threat assessment) of objects of inspection (checked bag, carry-ons parcel, personnel) for security screening applications.

### Open Platform Software Library (OPSL)

An API may be designed to help standardize a set of rules how software components communicate with other software components. A system may be configured to implement an Open Architecture API. A system implementing an open architecture API may offer more interoperable software services to access and process data transfers between components, increased software reusability, improved conformance with best coding practices, and better adherence to cybersecurity standards as compared to systems that do not implement an open architecture API. OPSL (open platform software library) is an example of a type of an open architecture API. OPSL may comprise a plurality of non-proprietary, vendor-neutral, middleware services.

### Middleware Services (MW)

The system 1 may be configured to execute or implement a middleware service (MW). For example, a component may be configured to implement the middleware service. The middleware service may standardize an application programming interface (API), define input/output and communication protocol, facilitate connecting screeners onto a common network, and leverage the common file format (such as DICOS) for exchanging data between major components across the network. The middleware service may comprise instructions for which AORAs (automated object of interest recognition algorithm) are run, how AORAs are run, how on-screen resolutions to anomalies should be generated, and manage an overall screening process.

### Software Development Kit (SDK)

OPSL may comprise a cross-platform Software Development Kit (SDK). The SDK may define the middleware interface standards. An SDK may be an implementation of agreed-upon interpretation of standards that a plurality of parties has approved. The SDK may comprise implementation examples. The SDK may comprise tools for testing infrastructure of an ORS. These infrastructure tools facilitate development and facilitate integration of AORAs to be run on an ORS because it establishes a common and non-proprietary interface. DICOS may also comprise an SDK for example.

### Object Recognition System (ORS)

An object recognition system (ORS) 300 may be constructed to combine computing hardware, DICOS, and OPSL into a platform supporting interoperable screening equipment (on-person, accessible property, checked baggage, etc.) while decoupling screeners from the AORAs, viewing stations, storage and operational logic that drives screening workflow through standardized APIs and communication protocols. The ORS may implement the standardized API defined by the SDK. The ORS may comprise or be connected to an on person screener, chattel screener, carry on screener, and/or checked item screener. A system may comprise multiple ORS, each ORS comprising or being connected to one or more on person screeners, chattel screeners, carry on screeners, and/or checked item screeners.

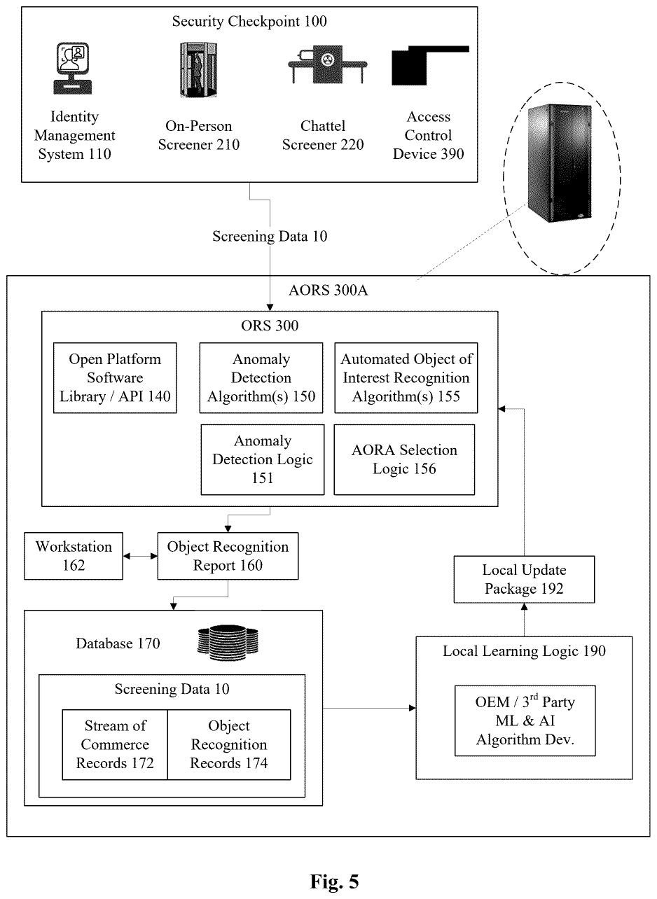

As show in FIG. 5, the ORS may comprise or be connected to an identity management system (IMS) 110 that may be configured to share configuration data on individuals (such as passengers). Configuration data may include a collection of data points for configuring or customizing the screening experience for that individual(s). The identity management system (IMS) 110 may validate biographic data, biometric data, and travel data based on a risk level associated with that person and employ OPSL to transfer the data to the ORS. The screening system may apply a screening methodology to reconfigure the screening of the passengers and their properties (carry-on, checked baggage, etc.) according to the data received from IMS 110 including for example traveler's risk level (e.g., no-fly, high-risk, low-risk, and so on). Reconfiguring the screening of passengers and their properties may expedite the screening process and mitigate known and unknown threats to aviation security. The IMS may determine an identity of a person by machine-based analysis of an identification substrate and verify the identity of the person by accessing an identity record in a database.

The ORS may be configured to use configuration data (e.g., information from the IMS 110, information about flights, information obtained about operations at other screening systems, etc.) to influence how algorithms are applied. For example, the passenger and their items may be provided tracking numbers to associate them together. The IMS, through OPSL, may be configured to communicate the passenger and their items info to the ORS. Then the ORS may be configured to use that info to apply specific detection algorithms to the passenger and item images that are appropriate, as determined by screening system based on the provided configuration data. The ORS may be configured to minimize cybersecurity vulnerabilities. The ORS may be configured to mitigate emerging cyber threats.

### Automated Object of Interest Recognition Algorithms (AORA)

Referring to FIG. 5, the ORS may comprise Automated Object of Interest Recognition Algorithms (AORAs) (155), also referred to herein as Automated Object Recognition Algorithm, configured to analyze visual media files (such as DICOS images) to identify objects of interest. Screening data may depict an object of interest or contain context data identifying a particular object as containing or likely containing an object of interest. An individual AORAs may be configured to detect certain type of objects. The ORS may comprise an AORA selection logic (AORASL) 156. The AORASL may select an AORA based on configuration data associated with the person or object being scanned. An AORA may be configured to analyze an individual object (such as a checked-item) or a person. The AORA may also consider the person, checked-item(s) and carry-on items when determining a threat level for a specific person to board a secure aircraft, enter a secure facility, enter a commercial building, etc.

The AORASL may select one or more AORAs based on checkpoint environment requirements (precheck lane, employee lane, etc.) The AORASL may select as a fail-safe AORA to maintain a level of screening operations. For example, if the ORS or network becomes unavailable (system crash, network failure, etc.) various components (such as 210, 220, etc.) may be configured to run the AORA locally (e.g., using their own processor and memory, etc.)

The ORS may be configured to run two or more AORAs concurrently or sequentially. In certain options wherein the ORS comprises more than two AORAs, the ORS may run the first AORA and the second AORA concurrently (in parallel) and the third may be run sequentially. In certain options wherein the ORS comprises more than two AORAs, the ORS may run the first AORA before running the second AORA and third AORA. In such configurations, the second AORA and third AORA may be run concurrently or sequentially.

The AORA may be configured to detect different objects of interest. Some configurations of the present invention may utilize a plurality of AORAs that may be designed to detect different objects of interest, be applied based on risk factors, run concurrently or sequentially, or other various configurations suited to the screening need.

As explained above, the ORS may comprise a plurality of AORAs. The ORS may comprise a first plurality of installed AORAs, a second plurality of uninstalled AORAs, and a third plurality of unknown AORAs. The ORS may be configured to activate or use a subset of installed AORAs. The ORS may be programmed to install or uninstall AORAs based on current or future detection needs. While the ORS may be capable of potentially having installed all known AORAs, licensing rights, memory limitations, and/or software conflicts may limit the utility of having all potential AORAs installed. Unknown AORAs may include developed algorithms that are not included within a data structure of installable AORA for a specific ORS implementation.

### Automated Object of Interest Recognition Algorithm Selection Logic (AORASL)

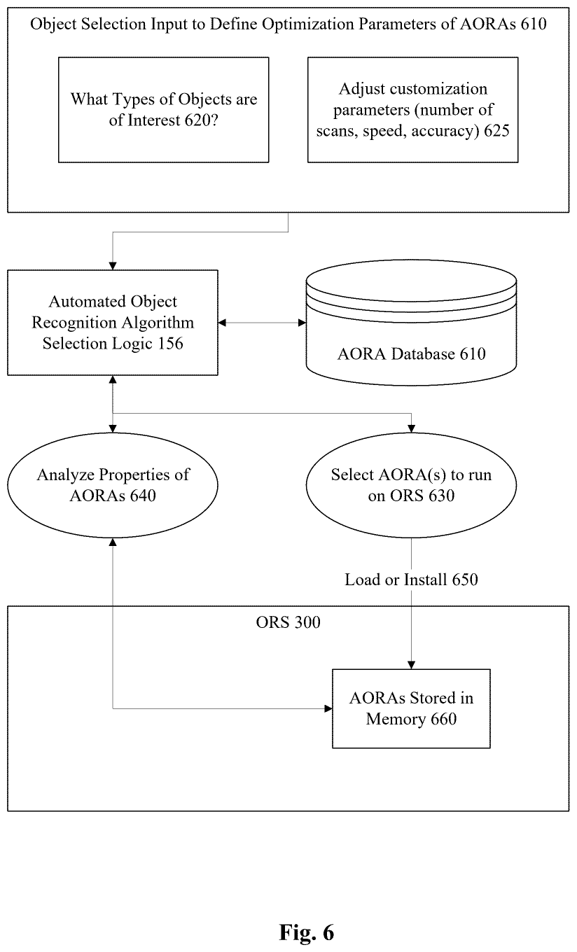

FIG. 6, the AORASL 156 may be configured to determine functionality of a first AORA relative to a second AORA. The AORASL may be configured to analyze 640 the functionality of all installed AORAs to determine an average, median, mode, or other statistical measurement of each of the AORA's ability to detect certain objects. The AORASL may comprise or be connected to an AORA Database 610. The AORA database may also comprise a record of standard values for properties of the AORAs such as detection speed, accuracy, memory load, etc. The AORASL may be configured to select 630 an optimal, improved/better AORA for a desired task. In this context, an optimal algorithm would be the algorithm that performs a certain type of detection faster, more efficiently, and/or more accurately than all other ATR (Automated Target Recognition) algorithms in the plurality of algorithms (suite of algorithms). An improved or better AORA may be considered an AORA that performs the detection faster, more efficiently, and/or more accurately than the average, mean, or other statistical measurement of the plurality of AORAs.

Certain AORAs may comprise more accurate, more sensitive, or more efficient processes for detecting a specific type of object of interest. The AORASL may be configured to select one or more AORAs 630 to improve the ORS's ability to detect a type of object. For example, the ORS may comprise an object selection input 610 that allows the ORS to be adjusted to detect certain types of objects with improved accuracy, sensitivity, or speed with respect by selecting certain AORAs from a plurality of AORAs. The selection input may be adjusted based on the types of objects that are of interest. 620. The selection input 620 may also comprise customization parameters 625 to select an AORA based on speed, accuracy, precision, licensing rights, costs, etc. For example, certain AORAs may be more accurate at inspecting carry-on luggage for explosives. If the operator of an ORS desires to reduce the number of false negatives for scans of carry-on luggage containing explosives, the AORASL may enable or turn on a specific AORA comprising improved accuracy for detecting explosives.

The AORASL may be configured to load or install 650 one or more AORA into memory 660 of the ORS 300. Through this process, an optimized suite (plurality) of AORAs can be selected so that the ORS can more efficiently screen for objects of interest.

### Stream of Commerce Data (SoCD)

Screening data such as an SoCD record may comprise a visual media file, an image, video, metadata, context data including for example: item-image-alarm characterization, scan performance, screening performance, travel data (time of day, destination, etc.) Some configurations of SoCD records may include data on users or passengers. Some configurations of SoCD records may specifically exclude storing data on user or passengers. Also some configurations of SoCD records may include configuration data for customizing the screening experience for the user or passenger. A security checkpoint (100) may be configured to collect SoCD during scanning of containers (such as accessible property, checked baggage, the bag itself) for threats and non-threat items. The anomaly detection algorithm 150 may leverage the SoCD pertaining to various locations (such as ports, businesses, military bases, private domiciles like houses, semi-private domiciles like apartment buildings, government buildings, etc.) to improve the algorithms ability to determine an anomaly. The ORS may be configured to use SoCD (stream of commerce data) and a learning logic.

### Anomaly Detection Algorithm (ADA) & Anomaly Detection Training Algorithm (ADTA)

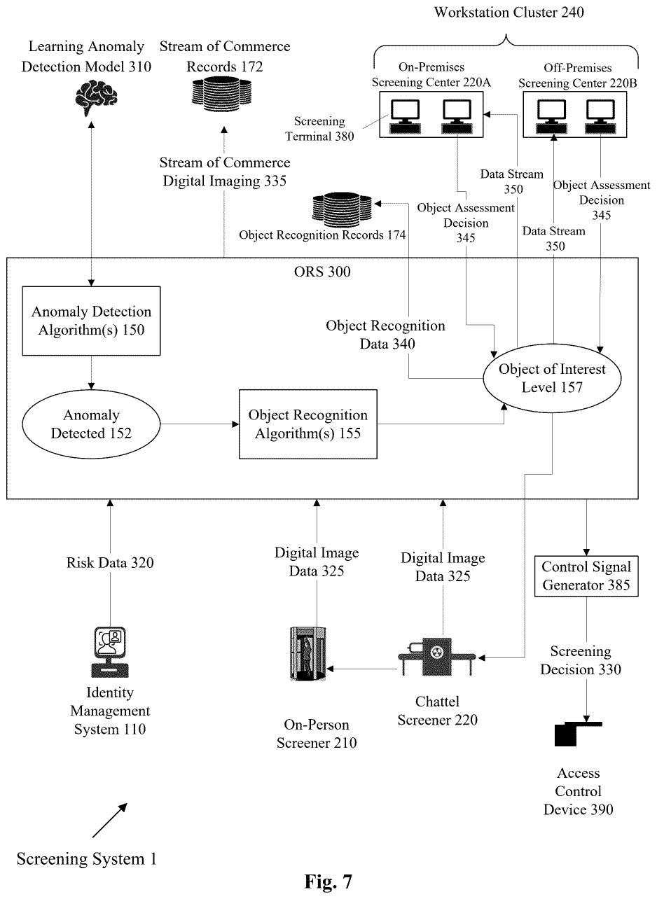

As shown in FIG. 7, an ORS may be configured to detect anomalies by using an anomaly detection algorithm (ADA) 150. The ADA may be configured to determine whether a visual media file a person, possession, container, carry-on or baggage contains an anomalous element. The ORS may be configured to categorize the anomalous element as an object of interest. The ORS using one or more object of interest algorithms may classify, categorize, or label one or more objects to be an “object of interest.”

An ORS may comprise an anomaly detection training algorithm (ADTA) configured to train and/or improve the accuracy, speed, efficiency, etc. of the anomaly detection algorithm (ADA). The ADA may be configured or trained using screening data generated and/or saved by security checkpoint 100 or an item screener 230. The screening data may comprise data relating to screening of people or objects. The screening data may also comprise context data including for example whether the screening data contains an object of interest.

Object of interest may include a high risk person (such as a person on a no-fly list), a prohibited item on the person (such as a firearm) , a prohibited item in a “carry-on” container (such as an explosive), or an item of concern in “checked luggage” (such as hazardous materials, etc.). A scanning system may be programmed to detect various other objects of interest.

The anomaly detection algorithm may be configured to determine a probability that a visual media contains an anomalous element; determine whether the probability is above an anomaly threshold; and generate a warning that a visual media file containing the anomalous element has been detected.

### Anomaly Detection Logic (ADL)

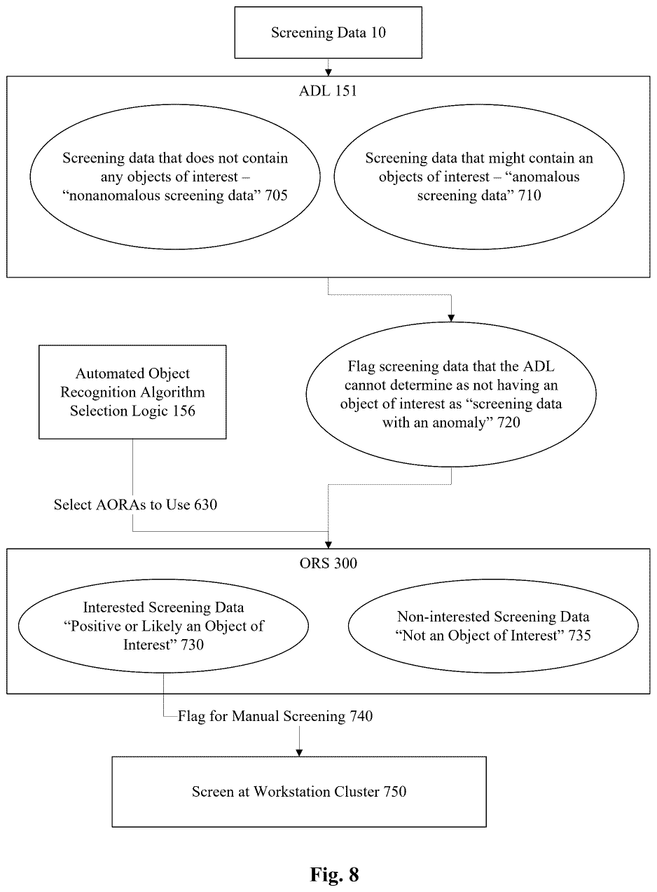

FIG. 8, an anomaly detection logic may be configured to analyze the screening data to determine whether the screening data contains screening data with no objects of interest 705 or screening data with anomalies 710. The anomaly detection logic (ADL) 151 may be configured to execute or run one or more Anomaly Detection Algorithms (ADAs) 150 to determine whether the screening data has no objects of interest or if it has an anomaly.

The anomaly detection logic (ADL) 151 may be configured to identify screening data that it cannot identify as not having an object of interest as screening data with an anomaly. In other words, the ADL may be configured to flag screening data that the ADL cannot determine as not having an object of interest as “screening data with an anomaly” 720.

The anomaly detection logic may be configured to classify screening data 10 as: (a) “non-anomalous screening data” e.g., screening data that does not contain any objects of interest, or (b) “anomalous screening data” e.g., screening data that might contain an object of interest. The ADL 151 may be configured to classify any screening data that it cannot classify as not containing an object of interest above a confidence threshold as anomalous screening data. The ORS 300 may be configured to cause the AORA to analyze the anomalous screening data for objects of interest. The AORA may classify the anomalous screening data as interested screening data or non-interested screening data. The AORA running on the ORS might be configured to classify anomalous screening data as interested screening data 730 when it cannot determine the anomalous screening does not contain an object of interest above a confidence interval. If the screening object is determined not to be an object of interest (e.g., not a threat for example), the object may be marked as not an object of interest. The ORS may flag objects determined to contain or likely contain an object of interest for manual screening 740. Manual screening may be performed by an operator via the workstation cluster 750. As explained above, the AORASL 156 may be configured to select the AORAs to run on the ORS 300 to improve efficiency or speed, etc.

### Screening Terminal, Workstation Cluster (WC) and Workstation (W)

The screening system 1 may comprise a screening terminal such as a workstation (W). The screening terminal may display information from the identify management system (IMS) 110. The screening terminal may highlight a portion of the image containing an object of interest on display or printout. The screening terminal may be electronically connected the screening device. The screening terminal may display information gathered from one or more detectors. The screening terminal may display an object of interest recognition report from the object of interest recognition algorithm indicating an object of interest level and factors used to determine the object of interest level.

The screening system 1 may comprise a workstation cluster 240. The workstation cluster (WC) may comprise one or more workstations (W) to display screening data such as screening images, object of interest information (potentially identified by an AORA). The screening system may also include a configuration where one workstation is collocated with each scanner versus a WC. The WC may comprise an on-premises screening center 220A, and/or an off-premises screening center 220B. Some configurations of the present invention may comprise multiple checkpoints 200, multiple container screeners 230, and multiple workspace clusters. In some configurations, each component may comprise a connected workstation.

The W may take the form of a computer, tablet, kiosk, or server. It may comprise common computer hardware components such as a processor, storage media for storing computer executable code (software) in a non-transitory form. The W may comprise a system bus, memory, a network interface, etc. The W may be configured to generate image manipulation tools to assist operators in making decisions whether screening data contain an anomaly and/or an image depicting an object of interest. The W may comprise a common graphical user interface (CGUI) and standardized hardware (such as a monitor or keyboard). A common graphical user interface may help reduce requirements for training, certification, and complexity for the screening operators.

The workstation cluster may comprise a screening room 221 comprising tables, tools, and other machines. An operator may privately or semi-privately screen data associated with a person, a container, or a package because of an AORA identified objects of interest, to determine or confirm the person, container, or package contains an object of interest. An operator may use the workstation in combination with the tools and machines in the screening room to obtain additional information about a potential object of interest.

The workstation cluster (WC) may comprise an on-premises screening system 220A and off-premises screening system 220B. An operator may use the on-premises screening system or off-premises screening system to form a human-based decision (“manual screening”) of the object of interest level (or a binary decision as to whether the object is an object of interest or not.)

### Database (DB)

Some configurations of the present invention may also comprise a database 170. The database may take the form of a data repository. The database may store screening data in a non-proprietary, standardized format (such as DICOS format) to support sharing with industry partners and government test facilities. Storage of screening data may be performed after a security checkpoint or container screener has completed screening a person, objects controlled by the person, containers controlled by the person, or checked objects controlled by the person (e.g., a “checked bag.”)

### Artificial Intelligence (AI) and Machine Learning (ML)

The screening system 1 may comprise an artificial intelligence (AI) algorithm. The artificial intelligence may comprise various types of AI such as machine learning (ML). The screening system may process the screening data to create, improve, and test ADTAs and ATDAs.

The artificial intelligence algorithm may be configured to receive a machine-made decision made by the anomaly and object recognition system; receive the human-made decision made by the operator of the screening system; and receive an update from an update algorithm; the update configured to improve accuracy, speed, or precision of the object of interest recognition algorithm using the received machine-made decision and human-made decision. The artificial intelligence algorithms may be designed to improve accuracy of the anomaly detection algorithm.

### Automated Object of Interest Recognition System (AORS) & ORS

FIG. 5 illustrates a process flow and system according to an aspect of the present invention. An identity management system 110 may capture identity information from a person attempting to pass through the security checkpoint 100. The identity management system (IMS) 110 may capture and validate biographic data, biometric data, and travel data associated with that person. The identity management system may employ OPSL to transfer the data to the ORS that may influence how detection algorithms are applied.

The AORS 300A may be configured to receive data from the identity management system 110, on-person screener 210, and chattel screener 220. In some configurations, an AORS is an ORS 300 and local learning logic 190. The AORS may comprise an Open Architecture API such as the open platform software library 140. The AORS may comprise an Anomaly Detection Algorithm (ADA) 150 and Automated Object Recognition Algorithm (AORA) 155. The AORS may generate an object recognition report (ORR) 160 that includes image data and detection data that may be securely sent to the workstation cluster (for example using the OPSL).

FIG. 5 illustrates that the AORS may store the ORR and image data from the on-person screener, IMS, chattel screener, and item screener in a database 170. A database may comprise a server and storage media configured to store various types of records. The database may also comprise database management software configured to a cause a processor of the server to store, sort, and return records in response to instructions. The database is shown to contain screening data 10 such as stream of commerce data (SOCD) 172 and object detection reports 174, but other configurations are possible.

FIG. 7 illustrates that the AORS may be configured to detect an anomaly 152 using the anomaly detection logic 151 and one or more anomaly detection algorithms 150. The AORS may generate and/or use a Learning Anomaly Detection Model (LADM) 310 to detect anomalies. When an anomaly is detected, the processor of the AORS can execute one or more AORAs 155 to evaluate the anomaly to determine if any objects of interest are detected and create an object detection report 160. The automated object of interest recognition algorithm (AORA) may also determine an object of interest level 157 of the object. In some configurations, the AORA 155 can determine a probability that a given object is an object of interest.

FIG. 5, in some configurations, the object recognition algorithm may be configured to determine whether an object is an object of interest or not (binary determination). Some configurations of the AORS 300A may use a plurality of AORAs. Some configurations of the AORS may select different AORAs based on a variety of factors such as the data from the identity management system (IMS) 110, current threat levels in the port of departure, etc. The IMS may be configured to acquire configuration data associated with the person; and the AORS may be configured to use the configuration data in order to adjust a screening configuration profile associated with the person and his or her objects. The AORA may be configured to determine a machine-based object of interest level.

When the AORA determines the screening data contains an object of interest or determines the screening data comprises an object of interest level above a threshold value, an operator may use the workstation cluster 230 to form a human-based decision as to whether related object is an object of interest. A workstation in the workstation cluster may contain a selector. The selector may contain an option to clear an alert associated with screening the object when the object is determined to not be an object of interest after screening at the workstation cluster. The selector may also flag the object for additional screening steps such as detaining the person, container or package, contacting law enforcement personal, summoning security personnel, possessions, chattels, or items. A machine learning algorithm may utilize data from the human-made decision to train the object of interest recognition algorithm to improve the accuracy, speed, or precision.

### Access Control Device (ACD)

The screening system may be connected to or comprise an access control device such as an electronic gate, turn style, or digital sign. The access control device may comprise a processor, memory, network interface, a physical barrier, a camera, computer code configured to cause the processor to perform a sequence of instructions, and a housing. A physical barrier may be made of plastic, wood, metal, stone, etc. The barrier may take the form of lock, gate, bars, plank, or other object that physically prevents an individual from through the access the control device or opening a second device controlled by the access device unless the access control device is an open or unlocked position. The access control device may comprise a computer, desktop, smartphone, wearable, etc. The access control device may comprise a door, lock, latch, box, gate, turnstile, or other barrier that blocks or restricts access or passage to a secure device, secure facility, or secure location. A secure device may be a laptop, terminal, circuit box, server, smart phone, weapon, vehicle, etc. A secure facility may be a shed, building, house, etc. A secure location may be an airport, airport gate, military base, room, desk, etc.

The access control device may be configured to switch from a first position (first state) to a second position (second state) when it receives a control signal from the screening system. The first position or first state may be a state that physically blocks or restricts, legally blocks or restricts, or otherwise limits, denies, or reduces access to a secure device, secure facility, or secure location. The second position or second state may be a state that does not physically block or restrict, legally block or restrict, or otherwise limit or reduce access to a secure device, secure facility, or secure location. The second position or second state may be a state that grants or provides physical access, legal access, security access to the secure device, secure facility, or secure location.

The access control device 400 may be configured to comprise a default position/state (which might be the first position or the second position.) The access control device may be configured to switch from the second position/state to the first position/state after an event occurs such as the passage of time period (5 seconds, 10 seconds, 1 minute, 5 minutes, 1 hour, 1 day, 10 days, etc.), a specific time and date in the future, an object or person is no longer detected within a preset radius of a sensor (e.g., a Bluetooth device is no longer within range of Bluetooth sensor); a user is no longer within a visible range of a camera connected to the access control device, a user no longer interacts with the access control device for a set period of time (e.g., a laptop logs out after a person stopped using the laptop for more than 15 minutes), etc.

The AORS may comprise a signal control generator 385 configured to generate a control signal to cause the access control device to switch from a first state to a second state. In some cases, the AORS and the access control device are a unity device. The access control device may display a first graphic, first colored light, first set of instructions, or first audio prompt. The second state may display a second graphic, second colored light, second of instructions, or second audio prompt. For example, the first colored light could be a red light indicating that the person should stop. The second colored light could be a green light indicating that the person should continue through the access control device. A first graphic could be a stop sign and a second graphic could be a green arrow. The first audio prompt could inform the person waiting at the access control device to wait. The second audio prompt could inform the person waiting at the access control device to proceed.

The AORS may comprise signal control generator 385 (or the access control generator may be a separate component) configured to generate a control signal to cause the access control device to switch from a first position and a second position. The first position may be designed to physically prevent the person from passing through the access control device 390 (such as a door prevents a person from passing through a threshold.) Similarly, the access control device may prevent the person from moving to a second location from the first location unless the access control is in the second position. In some configurations, the second position may be a “open” position while the first position is a “closed” position. The AORS 300 may physically comprise the access control device 390, vice versa, or they may be separate components as shown.

Security checkpoints and item scanner systems may comprise a conveyor system or moving platform to move items through the screening process such as an item being submitted for screening, screening of the item by the chattel or item screener, and the item continuing to the sterile or airplane or being sent for additional screening. The conveyor system may be configured with automated diverters to move items automatically along the conveyor system based on screening results.

The ORS 300 may transmit screening data (e.g., stream of commerce data 335) into the database 170. The database may comprise stream of commerce records 172 or screening record. The ORS 300 may store object of interest detection reports 157 and image data into the database as object recognition records 174. In some configurations, the ORS may transmit an object of interest detection reports to the chattel screener 220 and on-person screener 210. This transmitted data can potentially be used operators to detain or question the person, adjust scanning settings on these devices, and/or improve AORA software on these devices.

### Sample Configurations

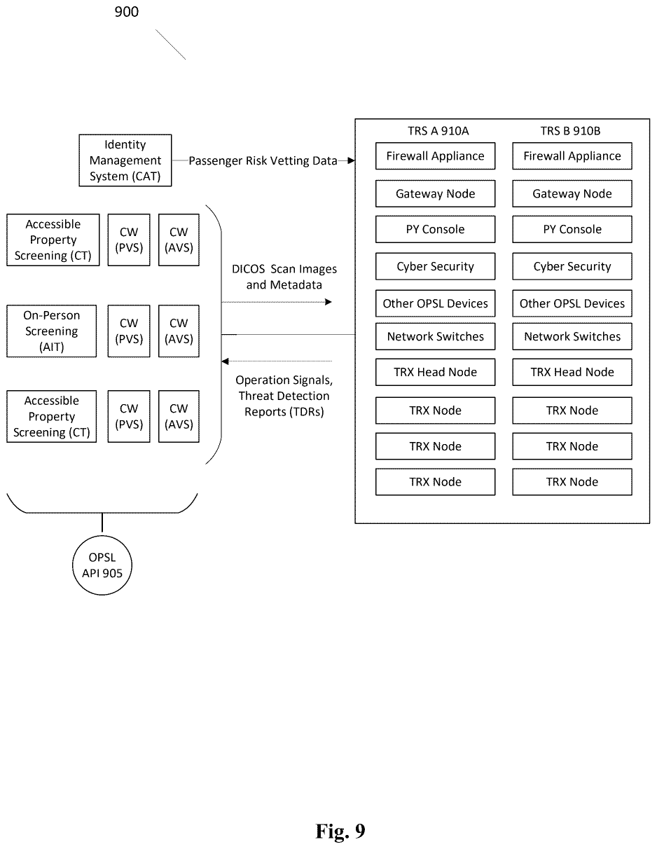

FIG. 9, the Threat Recognition System (TRS) 900 (TRS is a specific type of ORS) may be designed to work with screening devices to achieve the TSA's open architecture (OA) vision of a connected transportation security system of systems. The TRS may combine the computing hardware, Open Platform Software Library (OPSL) middleware 905, a suite of Automated Target Recognition (ATR) algorithms, DICOS standard, data archive, and local area network to provide an OA platform connecting screening devices such as Computed Tomography (CT), Advanced Imaging Technology (AIT), and Common Workstation (CW), while facilitating real-time, secure communication between systems. The TRS may provide a plug-and-play, vendor-neutral platform that decouples original equipment manufacturer (OEM) scanners from ATR algorithms, viewing stations, storage, and operational logics that drives screening workflows. PVS: primary viewing station. AVS: alternate viewing station. CAT: credential authentication technology (biometrics, driver's license recognition, or other information that could potentially help indicate risk). TRX is shorthand for TRS Server that hosts a suite of ATR algorithms. Additionally, environmental factors in addition to passenger risk may be factored into making a decision.

The NEMA DICOS standard may provide a data exchange protocol and interoperable, extensible file format to facilitate data exchange (CT images, 2D and 3D X-ray radiographs, AIT images, trace detection signature, risk assessment, threat detection reports, etc.) of objects of inspection (checked baggage, accessible property, persons, etc.) for security screening applications.

TRS Data Collection and Storage. For live data, the TRS might or might not collect, process, or store live passenger data. The TRS may collect and process DICOS scan images without containing any passenger's personal identifiable information (PII). For data storage, the TRS may store DICOS scan images and Threat Detection Reports (TDRs) in a short-term data Archive for a minimum term (such as 16 hours) and can be scaled up in a long-term storage as needed.

The TRS may comprise an A/B redundant system that provides failover capability to switch screening operation from a primary TRS A 910A to a backup TRS B 910B. The OPSL 905 middleware may standardize data between systems and provide an open and vendor neutral platform for ATR algorithms to run on the TRS. Abbreviations used in FIG. 9 include: TRS Threat Recognition System; OPSL-Open Platform Software Library; TRX-TRS Server; ATR Automated Target Recognition; CW-Common Workstation; PVS-Primary Viewing Station; AVS-Alternate Viewing Station; CAT-Credential Authentication Technology; CT-Computed Tomography; AIT-Advanced Imaging Technology; TDR-Threat Detection Report.

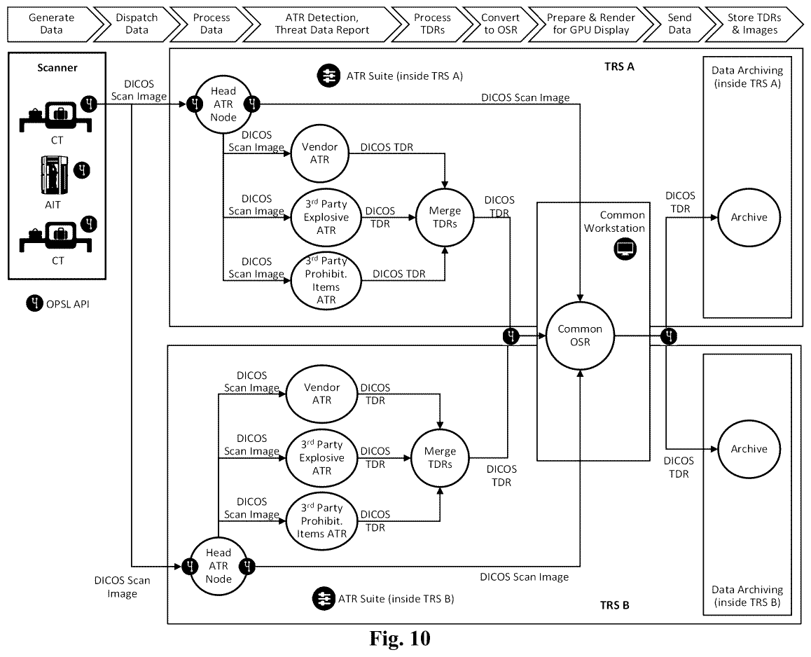

FIG. 10, OPSL may be a suite of vender-neutral middleware services that establishes standardized application programming interface (API), facilitates connecting screening devices onto a common network through a network interface card (NIC), and leverages DICOS standard for real-time data exchanges between systems across the network for ATR threat detection, on-screen resolution (OSR), data archiving, and dynamic screening workflow. OPSL may also offer a cross-platform Software Development Kit (SDK) that may define the middleware interface standardization as well as the inputs, outputs, and operation role each component plays within the screening workflow. The OPSL SDK may contain implementation examples and testing infrastructure tools that enable the development and integration of third-party ATRs to be run on the Threat Recognition System (TRS). The OPSL SDK may facilitates collaboration between software and algorithm developers, OEM equipment providers, system integrators, and airport security operators to improve adaptability and cost-effectiveness of security threat detection application deployment. The configuration shown in FIG. 10 may include a feedback loop to the scanner (not shown.)

### Hardware Configurations

The ORS 300 may include a hardware processor communicatively coupled to an instruction memory and to a data memory by a bus. The instruction memory can be configured to store, on at least a non-transitory computer readable medium as described in greater detail below, executable program code. The hardware processor may include multiple hardware processors and/or multiple processor cores. The hardware processor may include cooperation with hardware processors from different devices. The server, hub, and endpoint may execute one or more basic instructions included in the executable program code. The server, hub, and endpoint can include a network interface communicatively connected to the bus, for interfacing to a local area network (LAN) and may connect to a wide area network (WAN), e.g., the Internet or a private area network. Also communicatively connected to the bus can be a GUI. The ORS and its OPSL device may also include a data storage, which can be accessible to the hardware processor via the bus.

The relationship between the executable program code of the middleware (MW) services (including the operating system) and the ORS hardware processor is structural; the executable program code is provided to the hardware processor by imparting various voltages at certain times across certain electrical connections, in accordance with binary values in the executable program code, to cause the hardware processor to perform some action, as now explained in more detail.

A hardware processor may be thought of as a complex electrical circuit that is configured to perform a predefined set of basic operations in response to receiving a corresponding basic instruction selected from a predefined native instruction set of codes facilitated by the OPSL middleware.

The predefined native instruction set of OPSL executable program codes is specific to the ORS hardware processor; the design of the processor defines the collection of basic operational logics to which the hardware processor will respond throughout the screening workflow, and this collection forms the predefined native instruction set of codes.

A basic instruction may be represented numerically as a series of binary values, in which case it may be referred to as a machine code. The series of binary values may be represented electrically, as inputs to the hardware processor, via electrical connections, using voltages that represent either a binary zero or a binary one. The hardware processor interprets the voltages as binary values.

Executable program code may therefore be understood to be a set of machine codes selected from the predefined native instruction set of codes. A given set of machine codes may be understood, generally, to constitute a logic. A set of one or more logics may be understood to constitute an application program or “app.” An app may interact with the hardware processor directly or indirectly via the middleware. An app may be part of the middleware.

### Computer Program Product

A computer program product is an article of manufacture that has a computer-readable medium with executable program code that is adapted to enable a processing system to perform various operations and actions.

A computer-readable medium may be transitory or non-transitory.

A transitory computer-readable medium may be thought of as a conduit by which executable program code may be provided to a computer system, a short-term storage that may not use the data it holds other than to pass it on.

The buffers of transmitters and receivers that briefly store only portions of executable program code when being downloaded over the Internet is one example of a transitory computer-readable medium. A carrier signal or radio frequency signal, in transit, that conveys portions of executable program code over the air or through cabling such as fiber-optic cabling provides another example of a transitory computer-readable medium. Transitory computer-readable media convey parts of executable program code on the move, typically holding it long enough to just pass it on.

Non-transitory computer-readable media may be understood as a storage for the executable program code. Whereas a transitory computer-readable medium holds executable program code on the move, a non-transitory computer-readable medium is meant to hold executable program code at rest. Non-transitory computer-readable media may hold the software in its entirety, and for longer duration, compared to transitory computer-readable media that holds only a portion of the software and for a relatively short time. The term, “non-transitory computer-readable medium,” specifically excludes communication signals such as radio frequency signals in transit.

The following forms of storage exemplify non-transitory computer-readable media: removable storage such as a universal serial bus (USB) disk, a USB stick, a flash disk, a flash drive, a thumb drive, an external solid-state storage device (SSD), a compact flash card, a secure digital (SD) card, a diskette, a tape, a compact disc, an optical disc; secondary storage such as an internal hard drive, an internal SSD, internal flash memory, internal non-volatile memory, internal dynamic random-access memory (DRAM), read-only memory (ROM), random-access memory (RAM), and the like; and the primary storage of a computer system.

Different terms may be used to express the relationship between executable program code and non-transitory computer-readable media. Executable program code may be written on a disc, embodied in an application-specific integrated circuit, stored in a memory chip, or loaded in a cache memory, for example. Herein, the executable program code may be said, generally, to be “in” or “on” a computer-readable media. Conversely, the computer-readable media may be said to store, to include, to hold, or to have the executable program code.

### Creation of Executable Program Code

Software source code may be understood to be a human-readable, high-level representation of logical operations. Statements written in the programming language provide an example of software source code.

Software source code, while sometimes colloquially described as a program or as code, is different from executable program code. Software source code may be processed, through compilation for example, to yield executable program code. The process that yields the executable program code varies with the hardware processor; software source code meant to yield executable program code to run on one hardware processor made by one manufacturer, for example, will be processed differently than for another hardware processor made by another manufacturer.

The process of transforming software source code into executable program code is known to those familiar with this technical field as compilation or interpretation and is not the subject of this application.

### User Interface

A computer system may include a user interface controller under control of the processing system that displays a user interface in accordance with a user interface logic, i.e., a set of machine codes stored in the memory and selected from the predefined native instruction set of codes of the hardware processor, adapted to operate with the user interface controller to implement a user interface on a display device. Examples of a display device include a television, a projector, a computer display, a laptop display, a tablet display, a smartphone display, a smart television display, or the like. The display may be configured to display at least one of the visual media files depicting the object of interest.

The user interface may comprise an input to facilitate the collection of inputs from a user. The user interface may be graphical user interface with one or more user interface objects such as display objects and user activatable objects. The user interface may also have a touch interface that detects input when a user touches a display device. The input may be a mouse, wheel, button, dial, keyboard or other machine-human interface.

A display object of a user interface may display information to the user. A user activatable object may allow the user to take some action. A display object and a user activatable object may be separate, collocated, overlapping, or nested one within another. Examples of display objects include lines, borders, text, images, or the like. Examples of user activatable objects include menus, buttons, toolbars, input boxes, widgets, and the like.

### Communications

The various networks are illustrated throughout the drawings and described in other locations throughout this disclosure, can comprise any suitable type of network such as the Internet or a wide variety of other types of networks and combinations thereof. For example, the network may include a wide area network (WAN), a local area network (LAN), a wireless network, an intranet, the Internet, a combination thereof, and so on. Further, although a single network is shown, a network can be configured to include multiple networks.

### Conclusion

For any computer-implemented embodiment, “means plus function” elements will use the term “means;” the terms “logic” and “module” have the meaning ascribed to them above and are not to be construed as generic means. An interpretation under 35 U.S.C. § 112(f) is desired only where this description and/or the claims use specific terminology historically recognized to invoke the benefit of interpretation, such as “means,” and the structure corresponding to a recited function, to include the equivalents thereof, as permitted to the fullest extent of the law and this written description, may include the disclosure, the accompanying claims, and the drawings, as they would be understood by one of skill in the art.

To the extent the subject matter has been described in language specific to structural features or methodological steps, it will be understood that the subject matter defined in the appended claims is not necessarily limited to the specific features or steps described. Rather, the specific features and steps are disclosed as example forms of implementing the claimed subject matter. To the extent headings appear in this description, they are for the convenience of the reader, not as limitations or restrictions of the systems, techniques, approaches, methods, or devices to those appearing in any section. Rather, the teachings and disclosures herein can be combined or rearranged with other portions of this disclosure and the knowledge of one of ordinary skill in the art. This disclosure generally encompasses and includes such variation. The indication of any elements or steps as “optional” does not indicate that all other or any other elements or steps are mandatory. The claims define the invention and form part of the specification. Limitations from the written description are not to be read into the claims.

Certain attributes, functions, steps of methods, or sub-steps of methods described herein may be associated with physical structures or components, such as a module of a physical device that, in implementations in accordance with this disclosure, make use of instructions (e.g., computer executable instructions) that may be embodied in hardware, such as an application-specific integrated circuit, or that may cause a computer (e.g., a general-purpose computer) executing the instructions to have defined characteristics. There may be a combination of hardware and software such as processor implementing firmware, software, and so forth, to function as a special purpose computer with the ascribed characteristics. For example, in embodiments a logic may comprise a functional hardware unit (such as a self-contained hardware or software or a combination thereof) designed to interface the other components of a system such as through use of an application programming interface (API). In embodiments, structures for a logic can be according to the logic's function or set of functions, e.g., in accordance with a described algorithm. This disclosure may use nomenclature that associates a component or logic with a function, purpose, step, or sub-step to identify the corresponding structure which, in instances, includes hardware and/or software that function for a specific purpose.

Titles and heading used throughout the specification are provided for navigational purposes only. They should not be considered as limiting or defining of the subject matter disclosed. Paragraphs and sections relevant to one figure or embodiment may be equally relevant to another figure.

While certain implementations have been described, these implementations have been presented by way of example only and are not intended to limit the scope of this disclosure. The novel devices, systems and methods described herein may be embodied in a variety of other forms; furthermore, various omissions, substitutions, and changes in the form of the devices, systems and methods described herein may be made without departing from the spirit of this disclosure.

The claimed invention is:

1. A screening system comprising:
an identity management system configured to:
determine an identity of a person by machine-based analysis of an identification substrate;
verify the identity of the person by accessing an identity record in a database;
an on-person screener configured to generate a visual media file of the person and objects carried by the person;
a chattel screener configured to generate a visual media file of a container and contents within the container;
an object recognition system (ORS) comprising:
a detector configured to detect radiation from a radiation source;
the radiation source configured to irradiate radiation into the container;
a platform comprising a loading area, a screening area for screening the container, and an exit area;
a non-volatile, non-transitory, tangible storage memory configured to store an anomaly detection algorithm and an object of interest recognition algorithm;
a processor configured to execute the anomaly detection algorithm and the object of interest recognition algorithm;
a power supply configured to provide power to the radiation source, processor, memory, and detector;
a housing comprising the detector, radiation source, power supply, processor, memory, and screening area;
the anomaly detection algorithm configured to determine whether the visual media file contains an anomalous element;
the object of interest recognition algorithm configured to determine whether the visual media file contains an object of interest, and determine whether the anomalous element is an object of interest; and
a screening terminal comprising:
a display configured to display at least one of the visual media files depicting the object of interest; and
an input configured to receive a human-made decision;
a control signal generator configured to send a control signal; and
an access control device configured to switch from a first position to a second position upon receipt of the control signal.

2. The screening system of claim 1 wherein:
the identity management system is configured to acquire configuration data associated with the person; and
the ORS is configured to use the configuration data in order to adjust a screening configuration profile associated with the person.

3. The screening system of claim 1 wherein the object recognition system comprises a plurality of object of interest recognition algorithms.

4. The screening system of claim 1 wherein the screening system comprises a plurality of screening terminals.

5. The screening system of claim 1 wherein the screening terminal is connected to one or more workstation clusters and screening centers.

6. The screening system of claim 1 wherein the screening system comprises a database configured to:
store stream of commerce records from the anomaly detection algorithm; and
store object of interest recognition records from the object of interest recognition algorithm.

7. The screening system of claim 1 wherein the screening system comprises a visual media file buffer configured to store visual media files of the objects carried by the person; the container; and contents within the container.

8. The screening system of claim 6 wherein the screening system comprises an artificial intelligence algorithm designed to improve accuracy of the anomaly detection algorithm, the artificial intelligence algorithm is configured to:
receive a machine-made decision made by the object recognition system;
receive the human-made decision made by an operator of the screening system; and
receive an update from an update algorithm; the update configured to improve accuracy, speed, or precision of the object of interest recognition algorithm using the received machine-made decision and human-made decision.

9. The screening system of claim 1 wherein the object recognition system is configured to designate at least one of the visual media files as containing the anomalous element.

10. The screening system of claim 9 wherein the object recognition system is configured to determine an object of interest level of the anomalous element.

11. The screening system of claim 1 wherein the screening terminal is configured to:
display information from the identity management system;
highlight a portion of an image containing the object of interest; and
display an object of interest recognition report from the object of interest recognition algorithm indicating an object of interest level and factors used to determine the object of interest level.

12. The screening system of claim 1 wherein the object recognition system is configured to use an application programming interface.

13. The screening system of claim 12 wherein the application programming interface comprises an open architecture framework.

14. The screening system of claim 1 comprising a metal detector configured to screen a person or a container for a metal object.

15. The screening system of claim 1 wherein the processor is configured to cause the anomaly detection algorithm to:
determine a probability that a visual media contains an anomalous element;
determine whether the probability is above an anomaly threshold; and
generate a warning that a visual media file containing the anomalous element has been detected.

16. The screening system of claim 1 wherein the access control device comprises a threshold, and the access control device physically blocks the person from passing through the threshold in the first position.

17. An object recognition system comprising:
a detector configured to detect radiation from a radiation source;
the radiation source configured to irradiate radiation into a container;
a platform comprising a loading area, a screening area for screening the container, and an exit area;
a non-volatile, non-transitory, tangible storage memory configured to store an anomaly detection algorithm and an object of interest recognition algorithm;
a processor configured to execute the anomaly detection algorithm and the object of interest recognition algorithm;
a power supply configured to provide power to the radiation source, memory, processor, and detector;
a housing comprising the detector, radiation source, power supply, processor, memory, and screening area;
the anomaly detection algorithm configured to:
determine whether a visual media file contains an anomalous element; and
designate the visual media file as containing the anomalous element;
the object of interest recognition algorithm configured to:
categorize the visual media file containing the anomalous element as containing an object of interest; and
designate the visual media file as depicting an object of interest;
the processor configured to send an access control signal to an access control device.

18. A method comprising:
verifying an identity of a person with an identity management system;
generating configuration data with the identity management system;
generating a visual media file of a person and objects carried by the person in an on-person screener;
generating a visual media file of a container and contents within the container with a chattel screener;
detecting radiation from a radiation source with a detector;
irradiate radiation into the container using a radiation source;
executing, with a processor, an anomaly detection algorithm and an object of interest recognition algorithm stored in non-volatile, non-transitory, tangible storage memory;
the anomaly detection algorithm determining whether at least one of the visual media files contain an anomalous element;
the object of interest recognition algorithm categorizing the anomalous element as an object of interest;
a screening terminal displaying at least one of the visual media files on a computer;
the screening terminal receiving a human-made decision with an input;
an object recognition system determining whether the anomalous element is an object of interest based on an output of the screening terminal and object of interest recognition algorithm;
generating an access control signal;
sending the access control signal to an access control device; and
switching an access control device from a first position to a second position upon receipt of the access control signal.

19. The method of claim 18 comprising:
the screening terminal displaying information from the identity management system; and
the screening terminal highlighting a portion of an image containing the object of interest.

20. The method of claim 18 comprising the screening terminal displaying an object of interest level and factors used to determine the object of interest level.
